(19) United States
(12) Patent Application Publication
(10) Pub. No.: US 2015/0298898 A1
(43) Pub. Date: Oct. 22, 2015

(54) SINGLE SERVE CAPSULE FOR PRODUCING A COFFEE BEVERAGE WITHOUT CREMA

(71) Applicant: K-FEE SYSTEM GMBH, Bergisch Gladbach (DE)

(72) Inventors: Gunter EMPL, Bergisch Gladbach (DE); Wolfgang EPPLER, Bergisch Gladbach (DE); Andre THROM, Koln (DE)

(73) Assignee: K-FEE SYSTEM GMBH, Bergisch Gladbach (DE)

(21) Appl. No.: 14/648,279

(22) PCT Filed: Nov. 25, 2013
(86) PCT No.: PCT/EP2013/074651

§ 371 Date: May 29, 2015

(30) Foreign Application Priority Data
Nov. 30, 2012 (DE) 10 2012 111 684.9

(51) Int. Cl. B65D 85/804; A23F 5/24

(52) U.S. Cl. CPC B65D 85/8043; A23F 5/24

(57) ABSTRACT

The invention relates to a single serve capsule for producing a coffee beverage. The single serve capsule has a capsule base body, in which a textile fabric and a beverage substance are arranged, said beverage substance being provided in the single serve capsule in order to be stored and to be contracted from said capsule through the textile fabric by means of pressurised hot water. The beverage substance is substantially in powder form and comprises roasted, ground coffee, and the textile fabric has a mass per unit area of at least 100 g/m².

The invention relates to a single serve capsule for producing a coffee beverage, wherein the single serve capsule has a capsule base body in which a textile fabric and a beverage substance are arranged, wherein the beverage substance is provided for storage in the single serve capsule and for extraction in the single serve capsule through the textile fabric by means of pressurized hot water, wherein the beverage substance is substantially pulverulent, comprises roasted, ground coffee, and wherein the textile fabric has a weight per unit area of at least 100 g/m².

Beverage preparations that are divided into portions in capsule or pad systems are generally known from the prior art. For example, generic single serve capsules for preparation of coffee and espresso are disclosed in documents EP 1792850 B1, EP 1344722 A1 and US 2003/0172813 A1. In addition, reference is made to the documents DE 102010034206, WO 2012/010317, WO 2012/038063 and DE 102011010534.

Single serve capsules for producing a beverage are preferably frustoconical or cylindrical and are produced, for example, from a deep-drawn plastic film or in a plastics injection molding process. They customarily have an open filling side having a flange, onto which a membrane (covering film) is sealed or glued, a closed or open capsule base, wherein, between the beverage substance and the capsule base, one or more assembly elements, such as, for example, a particle sieve, a liquid distributor, a fleece, a felt, a shutoff film and/or the like can be present.

To prepare a coffee beverage, the single serve capsule is introduced into a brewing chamber of a preparation apparatus. After, or during, the closing process of the brewing chamber, the single serve capsule is preferably opened on the closed base side thereof by means of an outlet spike arranged in the brewing chamber. Single serve capsules having partially open capsule bases already have one opening on the base side thereof. After the brewing chamber is sealed off, the filling side of the single serve capsule that is closed by a membrane or covering film is pierced by piercing means. Subsequently, preparation liquid, preferably hot water, is transported under pressure into the single serve capsule. The preparation liquid flows through the beverage substance and extracts and/or dissolves from the beverage substance the substances that are required for beverage production.

In the preparation of an espresso, for example a brewing water pressure of up to 20 bar acts on the coffee powder to extract the essential oils. This pressure, in addition, also acts on the filter medium which is situated between the coffee powder and the pierced capsule outlet of the capsule base. The sudden pressure drop on the bottom side of the filter medium leads to foam formation in the beverage, for example in the form of a crema of a coffee beverage.

Crema is obtained through the fineness of the particles, the filter system and a high pressure in the extraction volume. If the system is unpressurized, no crema is formed.

For certain beverages, for example the classic filter coffee without crema, which is consumed, in particular in the USA and Scandinavia, foam formation, however, is unwanted.

The amount of ground coffee required to obtain the desired beverage volume, which amount is present in a single serve capsule, increases virtually linearly with the beverage volume when the further charge material characteristics such as degree of roasting and degree of grinding correspond to the standard.

It is known that, particularly in the case of beverage amounts of greater than 150 ml, the additional extraction of the coffee grounds leads to washing-out of unwanted taste components which give the end product a bitter, acidic, stale taste. Obvious correction measures could be to increase the weighed portion or to grind the coffee beans finer. Increasing the weighed portion, however, leads to a poorer extraction, since the extraction medium can no longer wash around the particles uniformly. The reduction of the medium particle size increases the pressure in the extraction space. This leads to an additional extraction of unwanted components.

In the prior art, there are already system solutions which offer absolutely differing beverage productivities with an unchangeable fixed volume of the single serve packaging. However, these systems provide a disproportional volume store of the single serve packaging.

There is a need for single serve capsules for producing coffee beverages which have a uniform size and therefore can be part of a system solution. The single serve capsules should have a high productivity for coffee beverages of different volumes that are faultless in sensory quality.

There is especially a need for single serve capsules for the production of preferably crema-free coffee beverages with volumes of preferably more than 80 ml, wherein the coffee contained in the single serve capsule can be used in a wide degree of grinding range (expressed as D[4,3] value) and at the same time coffee beverages of good sensory quality can be obtained.

The D[4,3] value is the median volume D[4,3] which is a measured parameter known to those skilled in the art and can be used for describing the medium particle size.

The object of the present invention was to provide single serve capsules for producing coffee beverages which have advantages over single serve capsules of the prior art.

In particular, beverage preparations that are divided into portions having variable, market-specific beverage productivities should be provided in a predetermined, small-volume unchangeable packaging or storage volume. The variable, market-specific beverage productivities to be achieved should be in this case preferably between 80 ml and 350 ml. In addition, the beverage preparations obtained should be equivalent or enhanced in sensory quality to the beverages prepared in the previously customary preparation apparatuses.

In addition, beverages which do not have a crema should be obtained which beverages therefore correspond to the beverages which are prepared with apparatuses of unpressurized filtration.

In addition, a system should be found with which coffee beverages which are faultless in sensory quality can be produced in a relatively high volume range (preferably 80 to 350 ml), wherein the degree of grinding (expressed as D[4,3] value) is variable and freely selectable in a relatively large range.

These objects are achieved by the present invention, i.e. a single serve capsule for producing a coffee beverage,

wherein the single serve capsule has a capsule base body in which a textile fabric and a beverage substance are arranged,
wherein the beverage substance is provided for storage in the single serve capsule and for extraction in the single serve capsule through the textile fabric by means of pressurized hot water,
wherein the beverage substance is present in the single serve capsule in an amount in the range from 1 to 20 g;
wherein the beverage substance is substantially pulverulent, comprises roasted, ground coffee which in the dry state has a D[4,3] value in the range from 100 to 800 μm; and
wherein the textile fabric has a weight per unit area of at least 100 g/m².

It has surprisingly been found that by the special combination of textile fabric, in particular the air permeability and the weight per unit area, degree of grinding of the roast coffee, amount of the coffee situated in the extraction volume and degree of roasting, the beverage respectively to be achieved with the desired freedom from crema and also the desired beverage volume can be set.

According to the invention, the parameters degree of roasting, degree of grinding and amount of coffee situated in the extraction volume (weighed portion) are varied and matched to one another in such a manner that even with very low weighed portions, high beverage volumes can be achieved, which correspond in sensory quality to the specifications. The yield of beverage volume per amount of coffee situated in the extraction volume can thus be improved.

The volume of the single serve capsule according to the invention is preferably in the range from 20 to 35 mL.

In a preferred embodiment, the volume of the single serve capsule according to the invention is 25±10 mL, more preferably 25±8 mL, still more preferably 25±6 mL, most preferably 25±4 mL, and in particular 25±2 mL.

In another preferred embodiment, the volume of the single serve capsule according to the invention is 30±10 mL, more preferably 30±8 mL, still more preferably 30±6 mL, most preferably 30±4 mL, and in particular 30±2 mL.

The beverage substance present in the single serve capsule according to the invention is substantially pulverulent and comprises roasted ground coffee.

The coffee can be of a single variety, or consist of a mixture of two or more of any desired coffee varieties.

In a preferred embodiment, the beverage substance present in the single serve capsule comprises one or more coffee varieties selected from Arabica, Robusta, and Liberica.

In a particularly preferred embodiment, the beverage substance present in the single serve capsule comprises roasted, ground coffee, wherein the coffee is a mixture of the coffee varieties Arabica and Robusta.

In a further particularly preferred embodiment, the beverage substance present in the single serve capsule consists of roasted, ground coffee, wherein the coffee is a mixture of the coffee varieties Arabica and Robusta.

In a preferred embodiment, the beverage substance present in the single serve capsule comprises roasted, ground coffee, wherein the coffee is exclusively Arabica coffee.

In a further preferred embodiment, the beverage substance present in the single serve capsule comprises roasted, ground coffee, wherein the coffee is exclusively Robusta coffee.

The coffee can be decaffeinated.

The coffee can be flavored. Flavored coffee is preferably obtained in that the coffee beans, after the roasting, are treated with natural or synthetic flavorings or oils.

The bulk weight of the roasted, ground coffee, depending on variety and degree of grinding, is 250 g/l to 400 g/l. The bulk weight is determined by means of the Hag instrument. For this purpose, the ground coffee is placed into a container of known volume (250 ml) which, before filling, is tared on the balance. The coffee is filled into the container to overflowing and is skimmed off level on the upper container rim using a flat item. The full container is weighed against the tare weight and converted to g/l by means of a factor known to those skilled in the art.

The roasted, ground coffee preferably has a specific surface area in the range from 5 to 90 m²/kg.

Preferably, the specific surface area of the coffee is 5±3 m²/kg, 10±5 m²/kg, 15±1 m²/kg, 32±1 m²/kg, 45±1 m²/kg, 55±1 m²/kg, 58±1 m²/kg, or 60±5 m²/kg.

The roasted, ground coffee preferably has a water content in the range from 1 to 5%.

In order to achieve beverages having different beverage volumes—with or without crema—the roasting of the individual varieties is an important element. In this operation, taste and color are affected.

The degree of roasting can be determined using a color measuring instrument (e.g. Colorette 3b from Probat, Emmerich, Germany).

In a particularly preferred embodiment, the total amount of the ground coffee which is present in the beverage substance is roasted.

The roasted, ground coffee has a color value (measured with Colorette 3b from Probat, constructed 2011) in a range from preferably 20 to 170, more preferably 30 to 150, still more preferably 40 to 130, and in particular 50 to 120.

The color value of roasted, ground coffee is a generally recognized factor for quantifying the degree of roasting. The color value is determined according to the invention using a color measuring instrument of the Colorette 3b type from Probat, constructed 2011. The principle of measurement is based on a reflection measurement. In this case the coffee sample that is to be measured is illuminated with light of two wavelengths (red light and infrared). The sum of the reflected light is evaluated electronically and is displayed as a color value.

The roasted, ground coffee has a degree of roasting which, expressed via the color value (measured with Colorette 3b from Probat; constructed 2011), is in the range from preferably 20 to 170, more preferably 30 to 120 or 30 to 100, still more preferably 40 to 100 or 40 to 80, most preferably 45 to 95 or 45 to 75, and in particular 50 to 90 or 50 to 70.

In another preferred embodiment, the roasted, ground coffee has a degree of roasting which, expressed via the color value (measured with Colorette 3b from Probat; constructed 2011), is in a range from 20 to 170, more preferably 50 to 150, still more preferably 60 to 130, most preferably 65 to 135, and in particular 70 to 120.

The color values (measured with Colorette 3b from Probat; constructed 2011) of particularly preferred degrees of roasting A¹ to A⁶ are listed in the table hereinbelow:

| | A¹ | A² | A³ | A⁴ | A⁵ | A⁶ |
|---|---|---|---|---|---|---|
| Colorette | 40-100 | 40-80 | 50-90 | 50-70 | 60-130 | 70-120 |
| color | | | | | | |
| value | | | | | | |

The beverage substance is substantially pulverulent and comprises roasted, ground coffee which in the dry state has a D[4,3] value in the range from 100 to 800 μm.

The D[4,3] value is the median volume D[4,3], which is a measured parameter known to those skilled in the art and can be used for describing the medium particle size.

Preferably, the beverage substance makes up all of the contents of the single serve capsule. If the beverage substance, in addition to the roasted, ground coffee, contains other solid components, in particular further pulverulent components, according to the invention the D[4,3] value relates to the totality of all particles. This also applies to blends of roasted, ground coffee, the components of which have independent, i.e. in the separated state, different D[4,3] values; in this case, according to the invention the D[4,3] value likewise relates to the totality of all coffee particles including any further pulverulent components present.

In a preferred embodiment, the beverage substance is substantially pulverulent, and comprises roasted, ground coffee which in the dry state has a D[4,3] value in the range from 200 to 650 μm.

In a further preferred embodiment, the beverage substance is substantially pulverulent, and comprises roasted, ground coffee which in the dry state has a D[4,3] value in the range from 300 to 400 μm, or 350 to 600 μm.

By selecting a defined degree of grinding (expressed as D[4,3] value) in combination with the textile fabric and the amount of weighed portion, the respective beverage may be prepared in the desired sensory quality. Methods for determining the particle size distribution and also the medium particle size are known to those skilled in the art. The D[4,3] value gives the median volume which according to the invention is preferably determined by laser measurement, for example using a Malvern Mastersizer 3000 and the dispersion unit Malvern AeroS. In this case, in a dry measurement, preferably approximately 7 g of ground roast coffee are transferred into the measuring cell at a dispersion pressure of 4 bar. With laser diffraction, the particle size distribution and the D[4,3] value may be determined by means of determining the scattered light and the resultant angle of diffraction according to the Fraunhofer theory.

The particle size, or the particle size distribution, of the ground coffee influences the brewing pressure, the formation of a crema and the taste of the coffee beverage.

In a preferred embodiment, the ground coffee, in the dry state, has a D[4,3] value in the range from 215 to 365 μm, more preferably 240 to 340 μm, most preferably 265 to 315 μm, and in particular 290 μm. In another preferred embodiment, the ground coffee, in the dry state, has a D[4,3] value in the range from 235 to 385 μm, more preferably 260 to 360 μm, most preferably 285 to 335 μm, and in particular 310 μm. In a further preferred embodiment, the ground coffee, in the dry state, has a D[4,3] value in the range from 255 to 405 μm, more preferably 280 to 380 μm, most preferably 305 to 355 μm, and in particular 330 μm. In another preferred embodiment, the ground coffee, in the dry state, has a D[4,3] value in the range from 275 to 425 μm, more preferably 300 to 400 μm, most preferably 325 to 375 μm, and in particular 350 μm. In a further preferred embodiment, the ground coffee, in the dry state, has a D[4,3] value in the range from 325 to 475 μm, more preferably 350 to 450 μm, most preferably 375 to 425 μm, and in particular 400 μm. In another preferred embodiment, the ground coffee, in the dry state, has a D[4,3] value in the range from 375 to 525 μm, more preferably 400 to 500 μm, most preferably 425 to 475 μm, and in particular 450 μm. In a further preferred embodiment, the ground coffee, in the dry state, has a D[4,3] value in the range from 425 to 575 μm, more preferably 450 to 550 μm, most preferably 475 to 525 μm, and in particular 500 μm. In another preferred embodiment, the ground coffee, in the dry state, has a D[4,3] value in the range from 475 to 625 μm, more preferably 500 to 600 μm, most preferably 525 to 575 μm, and in particular 550 μm. In a further preferred embodiment, the ground coffee, in the dry state, has a D[4,3] value in the range from 550 to 750 μm, more preferably 600 to 700 μm, most preferably 625 to 675 μm, and in particular 650 μm. In another preferred embodiment, the ground coffee, in the dry state, has a D[4,3] value in the range from 650 to 800 μm, more preferably 700 to 800 μm, most preferably 725 to 775 μm, and in particular 750 μm.

Particularly preferred embodiments B¹ to B⁸ are summarized in the table hereinafter:

| | B¹ | B² | B³ | B⁴ | B⁵ | B⁶ | B⁷ | B⁸ |
|---|---|---|---|---|---|---|---|---|
| D[4,3] | 290 ± 25 | 310 ± 25 | 330 ± 25 | 350 ± 25 | 400 ± 25 | 450 ± 25 | 500 ± 25 | 550 ± 25 |
| VALUE | | | | | | | | |
| [μm] | | | | | | | | |

Very particular preference is given to embodiments B⁴ to B⁸.

On the basis of the D[4,3] value, an optimum ratio between extraction efficiency and extraction rate firstly, and filtration rate, secondly, can be set.

In a preferred embodiment, the entire amount of ground coffee in the dry state has the same particle size.

In a particularly preferred embodiment, the ground coffee has a defined mixture of different particle sizes.

The preferred particle size distributions are summarized in the table hereinbelow (embodiments C¹ to C¹⁰):

| Particle | | | | | |
|---|---|---|---|---|---|
| size in μm | C¹ | C² | C³ | C⁴ | C⁵ |
| <100 | 20-30 | 20-40 | 20-30 | 15-25 | 12-23 |
| >100 | 27-37 | 25-35 | 20-30 | 10-15 | 11-16 |
| >250 | 33-43 | 30-45 | 40-50 | 40-45 | 42-47 |
| >500 | 5-10 | 5-15 | 5-15 | 15-25 | 16-26 |
| Dv 50 μm | 250 ± 25 | 290 ± 25 | 310 ± 25 | 350 ± 25 | 400 ± 25 |
| Particle | | | | | |
| size in μm | C⁶ | C⁷ | C⁸ | C⁹ | C¹⁰ |
| <100 | 5-10 | 0-5 | 0-5 | 0-5 | 0-5 |
| >100 | 13-25 | 15-20 | 5-10 | 5-10 | 5-10 |
| >250 | 45-60 | 35-45 | 32-43 | 30-40 | 20-35 |
| >500 | 20-40 | 40-50 | 45-70 | 50-70 | 55-80 |
| Dv 50 μm | 450 ± 25 | 500 ± 25 | 550 ± 25 | 600 ± 25 | 650 ± 25 |

Particularly preferred embodiments are C² to C⁸.

The beverage substance is present in the single serve capsule in an amount in the range from 1 to 20 g.

Preferably, the beverage substance is present in the single serve capsule in an amount in the range from 2 to 11 g, more preferably 3 to 8 g, or 4 to 11 g, still more preferably 4 to 7 g, or 5 to 11 g, most preferably 4.5 to 6.5 g, or 6 to 10 g, and in particular 5 to 6 g, or 7 to 10 g.

In a preferred embodiment, the beverage substance is present in the single serve capsule in an amount in the range from 4 to 11 g.

In a particularly preferred embodiment, the beverage substance is present in the single serve capsule in an amount of 6±2 g, more preferably 6±1.5 g, still more preferably 6±1 g, most preferably 6±0.5 g, and in particular 6±0.3 g.

In another preferred embodiment, the beverage substance is present in the single serve capsule in an amount of 7.7±4 g, more preferably 7.7±3 g, still more preferably 7.7±2 g, most preferably 7.7±1 g, and in particular 7.7±0.5 g.

In a particularly preferred embodiment, the beverage substance is present in the single serve capsule in an amount of 8±4 g, more preferably 8±3 g, still more preferably 8±2 g, most preferably 8±1 g, and in particular 8±0.5 g.

In a further particularly preferred embodiment, the beverage substance is present in the single serve capsule in an amount of 9±4 g, more preferably 9±3 g, still more preferably 9±2 g, most preferably 9±1 g, and in particular 9±0.5 g.

The beverage substance can optionally contain additives such as chocolate powder, milk powder, tea powder, sweeteners such as sugar or sugar replacers, spices or the like.

In a preferred embodiment, the beverage substance does not contain any additives and consists exclusively of roasted, ground coffee.

The single serve capsule for producing a coffee beverage has a capsule base body in which a textile fabric and a beverage substance are arranged, wherein the beverage substance is provided for storage in the single serve capsule and for extraction in the single serve capsule through the textile fabric by means of pressurized hot water.

The capsule base body is preferably a deep-drawn capsule base body, which is preferably frustoconical or cylindrical.

The capsule base body additionally has a wall region, wherein the wall region preferably has a plurality of grooves, and the grooves are provided running between the membrane which closes the open filling side, and the base region over at least a part of the height extension of the wall region. These grooves have the effect that the single serve capsule has a higher mechanical stability and an improved behavior during flow of the extraction liquid through the single serve capsule in the brewing chamber, whereby an improvement of the extraction process can be induced.

Preferably, the capsule base body, in the region of the recess, has a greater diameter than in the wall region between the recess and the base region. As a result, this advantageously yields a particularly simple and robust possibility for inducing stackability of the single serve capsules and/or stackability of the capsule base body of the single serve capsules.

In a further preferred embodiment, the ratio of the diameter of the wall region adjacent to the flange/rim region, firstly, to the diameter of the flange, secondly, is between 0.85 and 0.89, and more preferably 0.87. In addition, the diameter of the wall region adjacent to the flange is preferably 39 mm and/or the diameter of the flange is preferably 45 mm.

In a further preferred embodiment, the capsule base body in the wall region between the base region and the flange has a lower wall thickness than in the region of the recess. According to this embodiment, the single serve capsule in addition preferably has grooves in the wall region, as a result of which an improved stability is achieved. A considerable material saving is possible hereby, as a result of which costs and energy expenditure for producing the single serve capsule can be reduced.

The height of the capsule base body from the base region to the flange is preferably 20 to 35 mm, more preferably 22 to 32 mm, still more preferably 25 to 29 mm, and most preferably 27 mm.

The single serve capsule consists, for example, of plastic, a natural material and/or a biodegradable material.

Preferably, the single serve capsule contains polyethylene; crosslinked polyethylene; polypropylene; copolymers of ethylene, propylene, butylene, vinyl esters and unsaturated aliphatic acids and also salts and esters thereof; vinylidene chloride copolymers; acetyl resins; acrylic and methacrylic acid ester polymers and copolymers thereof; polyisobutylene; isobutylene copolymers; polyterephthalic acid diol esters; polyvinyl ethers; silicones; unsaturated polyester resins; polycarbonates and mixtures of polycarbonates with polymers or copolymers; polyamides; polystyrene, styrene copolymers and graft polymers; polyvinyl chloride; polybutene; polyurethanes; poly(4-methyl-1-pentene); crosslinked polyureas; acrylonitrile copolymers and graft polymers; polyacrylates; starch plastics such as thermoplastic starch; polylactide copolymers or thermoplastic polyesters of polyhydroxy fatty acids.

The capsule base body can be colorless or colored in any desired color. In addition, the capsule base body can be transparent, translucent or opaque.

Preferably, the capsule base body is colored and opaque.

The outside of the capsule base body can be printed.

The capsule base of the single serve capsule can be partially open or closed.

In a preferred embodiment, the capsule base of the single serve capsule is closed.

According to this embodiment, the capsule base is first perforated in the brewing chamber by means of a perforating means acting from the outside onto the single serve capsule base for generating an outlet opening.

In a particularly preferred embodiment, the capsule base of the single serve capsule is partially open.

In the case of single serve capsules having a partially open capsule base, the opening, for product protection, is closed by means of a seal which, for example, is perforatable by means of the perforating means, or can be taken off manually from the capsule base. Such single serve capsules are known in the prior art.

According to this embodiment, the opening in the capsule base is preferably arranged centrally and preferably has a circular structure.

The relative ratio between the area of the opening in the capsule base and the area of the entire capsule base is preferably in the range from 0.08 to 0.13; more preferably 0.09 to 0.12; still more preferably 0.09 to 0.11, and is most preferably 0.10.

The single serve capsule is preferably hermetically tightly sealed, i.e. the beverage substance situated in the single serve capsule is substantially aroma-tightly sealed from the environment before the extraction process.

The open filling side of the capsule base body is closed by a membrane or covering film.

The membrane or covering film can be fabricated from the same material, or from another material, as the capsule base body, and is preferably fastened to the capsule base body by sealing and/or gluing.

Preferably, the membrane comprises one or more layers of different plastics having the barriers necessary for product protection; inter alia optionally aluminum foil. The compositions necessary therefor are known to those skilled in the art.

Preferably, the outside of the membrane, i.e. the side facing away from the filling, is partly or completely printed.

In the capsule base body of the single serve capsule, a textile fabric is arranged which acts as filter. Textile fabrics in the meaning of the invention comprise flat, i.e. two-dimensionally extending structures which comprise fibers. The fibers themselves can form any type of textiles, in particular woven fabric, fleeces, felts, sponges, etc.

In single serve capsules for beverage production, different textile fabrics can be used as filters. Different embodiments comprise flat and flexible to rigid and three-dimensional textile fabrics. Particular preference is given to porous-cascade-type textile fabrics according to the invention. With porous-cascade-type textile fabrics, a sufficient high brewing pressure is achieved in the extraction volume which delivers a beverage of faultless sensory quality. At the same time, the beverage substance is retained to the desired extent in the extraction space and the foam formation for achieving the crema on the beverage can be prevented.

Porous-cascade-type textile fabrics have a markedly three-dimensional structure which contains pore-like cavities, wherein the liquid flowing through which is to be filtered flows as in a cascade from pore level to pore level. Any foam present is broken and does not form a crema.

Flat-permeable textile fabrics have a flat paper-thin form. Owing to randomly arranged fibers having few layers arranged one above the other, a textile fabric of low mesh width results. The close-fitting filter feed generates sufficient pressure to extract crema-forming substances.

The use of a textile fabric as filter has the advantage that a complex plastic injection process or deep-drawing or embossing process for producing plastic sieves can be omitted. The product costs are thereby considerably reduced. In addition, no support structure is necessary, since the textile fabric is directly supported on the capsule base. In comparison with the plastics filters known from the prior art, the textile fabric in addition has the advantage that it has a markedly larger liquid intake surface area. In addition, liquid crossflow is permitted (in parallel to the principal plane of extension of the filter plane), whereby an improved mixing and effluent behavior is achieved. Furthermore, it has been found that when a textile fabric is used the risk of sieve blockages is markedly reduced or is virtually eliminated. The textile fabric is blockage-resistant not only in the case of a beverage preparation having a preparation liquid under comparatively low pressure, but also in the case of a beverage preparation having a preparation liquid at comparatively high pressure. In addition, a liquid crossflow is reliably always maintained in the textile fabric, and effluent of the liquids entering into the textile fabric to an effluent opening is ensured.

The textile fabric is preferably constructed in a tear-resistant manner.

The textile fabric preferably comprises a fleece, felt and other textiles or structures having pores and channels such as open-pore sponges, open-pore foam or a combination thereof.

In a preferred embodiment of the present invention, the textile fabric is a fleece which comprises a fleece material produced from fine plastic fibers such as, for example, fine polyester fibers and which, in particular, is a random-fiber and/or fiber-oriented fleece material. The fleece is preferably flat-permeable.

In a particularly preferred embodiment of the present invention, the textile fabric has a felt structure. The textile fabric can have one or more felt structures arranged one above the other. The felt is preferably of porous-cascade type and can comprise, for example, viscose, polyester, polyamide, polypropylene or combinations thereof. A plurality of fleeces and/or felts can be combined one after the other. Particularly preferably, the felt has a needle felt structure. According to this embodiment, the textile fabric preferably consists of at least one felt structure and one supporting structure, in particular a woven fabric structure, wherein the felt structure particularly preferably comprises the supporting structure at least in a partial section of the volume. Preferably, the textile fabric has two felt structures which are separated from one another by the supporting structure. Preferably, the two felt structures are arranged one above the other in the single serve capsule and are bonded to one another. The thickness of the two felt structures can be identical or different. Preferably, a felt structure facing the beverage substance is thinner than the felt structure facing the capsule base, or vice versa. Preferably, the surface of the felt structure is treated, for example heat-treated, in order to fix loose fibers, for example.

A textile fabric which has a supporting structure, in particular a woven fabric structure, and a felt structure, can be produced, for example, in that a woven fabric structure consisting of longitudinal and transverse threads is provided. For the construction of a felt, in particular a needle felt, preferably fiber units are selected from 0.8 to 7 dtex. The combination of the individual fibers with one another to form a felt and/or anchoring thereof in the supporting structure takes place preferably via the production process of needling. In this case, needles having reverse barbs are stabbed at high velocity into the presented fiber package and pulled out again. Owing to the barbs, the fibers, via a multiplicity of resulting loops, are intertwined with one another and/or with the supporting woven fabric.

When the textile fabric comprises both a felt and a fleece, they are preferably bonded to one another. The felt and/or the fleece can be used as multilayers, wherein the layers can differ in the type of starting material used and/or the processing thereof.

In a further preferred embodiment of the present invention, the textile fabric is a filter woven fabric, e.g. an open-pore sponge and/or an open-pore foam which is arranged in the region of the capsule base. The sponge comprises, for example, a reticulated polyurethane foam.

In a preferred embodiment, the textile fabric is flat-permeable, preferably a flat-permeable fleece.

When the textile fabric is a flat-permeable fleece, the capsule base of the single serve capsule is preferably closed.

In a particularly preferred embodiment, the textile fabric is of porous-cascade type, preferably a porous-cascade-type felt.

When the textile fabric is a porous-cascade-type felt, the capsule base of the single serve capsule is preferably partially open.

Textile fabrics have a certain extensibility in the longitudinal and transverse directions. Depending on material thickness and composition and/or structure of the material, the extensibility is determined, e.g., as specified in ISO 9073 or, e.g., as specified in ISO 13934. According to the invention, the extensibility of the textile fabric is preferably determined as specified in ISO 9073 or as specified in ISO 13934.

When the textile fabric is a fleece and the material thickness is less than one millimeter, the maximum tensile force in the longitudinal direction is preferably 50 N to 150 N per 5 cm and in the transverse direction preferably 30 N to 90 N per 5 cm, wherein the maximum tensile force extension in the longitudinal and transverse directions preferably comprises 20% to 40%.

If the material thickness is more than one millimeter, the maximum tensile force in the longitudinal and transverse directions is preferably 40 daN to 120 daN, wherein the maximum tensile force extension in the longitudinal and transverse directions is 20% to 40%.

The textile fabric has a plurality of filter openings, wherein the filter openings preferably a medium diameter in the range from 100 to 1000 μm, more preferably 200 to 700 μm, most preferably 250 to 550 μm, and in particular 300 to 500 μm. Methods for determining the medium diameter of the filter openings are known to those skilled in the art.

In a preferred embodiment, the textile fabric has a plurality of filter openings which are constructed in such a manner that the sum of the cross sections of the filter openings comprises between 0.1 and 10%, more preferably between 1 and 3%, and most preferably 1.4%, of the total cross section of the textile fabric.

The medium diameter of the filter openings and the D[4,3] value are matched to one another in such a manner that no particles of the beverage substance pass into the coffee beverage and at the same time an extraction of the beverage substance that is as rapid and efficient as possible is achieved.

The air permeability of textile fabrics is determined as specified in DIN ISO 9237. For this purpose, a defined area of the sample material is tensioned. Air flows through the sample perpendicularly to the surface. The measurement can proceed as vacuum or differential pressure determination. The air permeability is preferably determined at a pressure of 100 pascals.

The textile fabric can have an air permeability in the range from 50 to 4000 l/(m²s).

Particularly preferred air permeabilities of the textile fabric are summarized in the table hereinafter as embodiments D¹ to D⁴³:

| | D¹ | D² | D³ | D⁴ | D⁵ | D⁶ | D⁷ | D⁸ | D⁹ | D¹⁰ |
|---|---|---|---|---|---|---|---|---|---|---|
| Air | 50-150 | 150-200 | 150-170 | 160-180 | 180-200 | 180-240 | 230-330 | 250-310 | 270-290 | 330-380 |
| permeability | | | | | | | | | | |
| [l/(m²s)] | | | | | | | | | | |
| | D¹¹ | D¹² | D¹³ | D¹⁴ | D¹⁵ | D¹⁶ | D¹⁷ | D¹⁸ | D¹⁹ | D²⁰ |
| Air | 350-450 | 370-430 | 390-410 | 400-500 | 480-580 | 550-650 | 630-800 | 780-900 | 880-1000 | 1000-1200 |
| permeability | | | | | | | | | | |
| [l/(m²s)] | | | | | | | | | | |
| | D²¹ | D²² | D²³ | D²⁴ | D²⁵ | D²⁶ | D²⁷ | D²⁸ | D²⁹ | D³⁰ |
| Air | 1200-1400 | 1400-1600 | 1600-1800 | 1800-2200 | 1900-2100 | 1980-2020 | 2200-2500 | 2500-3000 | 3000-3500 | 3500-4000 |
| permeability | | | | | | | | | | |
| [l/(m²s)] | | | | | | | | | | |

| | D³¹ | D³² | D³³ | D³⁴ | D³⁵ | D³⁶ | D³⁷ |
|---|---|---|---|---|---|---|---|
| Air | 160 ± 10 | 170 ± 10 | 193 ± 10 | 281 ± 10 | 400 ± 10 | 600 ± 100 | 800 ± 100 |
| permeability | | | | | | | |
| [l/(m²s)] | | | | | | | |

| | D³⁸ | D³⁹ | D⁴⁰ | D⁴¹ | D⁴² | D⁴³ |
|---|---|---|---|---|---|---|
| Air permeability | 1000 ± 100 | 1500 ± 100 | 1700 ± 100 | 2000 ± 50 | 2100 ± 50 | 2500 ± 100 |
| [l/(m²s)] | | | | | | |

In a preferred embodiment, the textile fabric has an air permeability of a least 50 l/(m²s).

In another preferred embodiment, the textile fabric has an air permeability of at least 100 l/(m²s).

Particularly preferably, the textile fabric has an air permeability of more than 160 l/(m²s).

When the textile fabric comprises fleece or consists of fleece, the embodiments D²⁴ to D²⁶ are preferred, and D⁴¹ is particularly preferred.

In a preferred embodiment, the textile fabric has an air permeability in the range from 160 to 500 l/(m²s).

When the textile fabric comprises felt or consists of felt, embodiments D² to D⁵, D⁷ to D⁹ and D¹¹ to D¹² are preferred, and D³² and D³⁵ are particularly preferred.

When the D[4,3] value is in the range from 380 to 580 μm, preferably 400 to 550 μm, the embodiment D³² is very particularly preferred.

When the D[4,3] value is in the range from 300 to 400 μm, preferably 320 to 380 μm, embodiment D³⁵ is very particularly preferred.

The textile fabric has a weight per unit area of at least 100 g/m². Alternative names for weight per unit area are area density or grammage.

Methods for determining the weight per unit area of a textile fabric are known to those skilled in the art. The weight per unit area is preferably determined as specified in DIN EN 12127.

Preferred embodiments E¹ to E²⁴ are summarized in the table hereinafter:

| | E¹ | E² | E³ | E⁴ | E⁵ | E⁶ | E⁷ | E⁸ | E⁹ | E¹⁰ |
|---|---|---|---|---|---|---|---|---|---|---|
| Weight | 10-150 | 30-120 | 50-100 | 60-80 | 150-300 | 300-1100 | 500-950 | 550-850 | 600-800 | 600-700 |
| per unit | | | | | | | | | | |
| area | | | | | | | | | | |
| [g/m²] | | | | | | | | | | |

| | E¹¹ | E¹² | E¹³ | E¹⁴ | E¹⁵ | E¹⁶ | E¹⁷ |
|---|---|---|---|---|---|---|---|
| Weight per | 900-1400 | 950-1350 | 1000-1300 | 1050-1250 | 1100-1200 | 1200-1400 | 1250-1350 |
| unit area | | | | | | | |
| [g/m²] | | | | | | | |

| | E¹⁸ | E¹⁹ | E²⁰ | E²¹ | E²² | E²³ | E²⁴ |
|---|---|---|---|---|---|---|---|
| Weight per | 70 ± 10 | 650 ± 10 | 760 ± 10 | 900 ± 10 | 1000 ± 10 | 1150 ± 10 | 1300 ± 10 |
| unit area | | | | | | | (2 · 650 ± 10) |
| [g/m²] | | | | | | | |

When the textile fabric comprises fleece or consists of fleece, embodiments E³ and E⁴ are preferred, and E¹⁸ is particularly preferred.

In a particularly preferred embodiment, the textile fabric has a weight per unit area of at least 500 g/m².

In a further particularly preferred embodiment, the textile fabric has a weight per unit area of more than 900 g/m².

In a further preferred embodiment, the textile fabric has a weight per unit area of 1150±10 g/m², more preferably 1150±8 g/m², still more preferably 1150±6 g/m², most preferably 1150±4 g/m², and in particular 1150±2 g/m². According to this embodiment, the textile fabric comprises preferably felt or consists preferably of felt.

When the textile fabric comprises felt or consists of felt, embodiments E⁸, E¹⁰, E¹¹, E¹⁵ and E¹⁷ are preferred, and E¹⁹ and E²³ are particularly preferred.

When the D[4,3] value is in the range from 380 to 580 μm, preferably 400 to 550 μm, the embodiment E²³ is very particularly preferred.

When the D[4,3] value is in the range from 300 to 400 μm, preferably 320 to 380 μm, embodiment E¹⁹ is very particularly preferred.

Preferred combinations of features are D²E¹¹, D¹¹E⁸, D⁴E¹⁴, D³²E²³ and D³⁵E¹⁹.

In a particularly preferred embodiment, the textile fabric has an air permeability of more than 160 l/(m²s) and a weight per unit area of more than 900 g/m².

In a further particularly preferred embodiment, the textile fabric has an air permeability of more than 160 l/(m²s) and a weight per unit area of more than 900 g/m², wherein the capsule base is partially open.

Preferably, the quotient of the weight per unit area in g/m² and the air permeability in 1/(m²s) of the textile fabric is at least 1 (gs)/l.

In a preferred embodiment, the quotient of the weight per unit area in g/m² and the air permeability in l/(m²s) of the textile fabric is at least 1 (gs)/l, more preferably at least 2 (gs)/l, still more preferably at least 3 (gs)/l, or 4 (gs)/l, most preferably at least 5 (gs)/l, and in particular at least 6 (gs)/l.

In a particularly preferred embodiment, the quotient of the weight per unit area in g/m² and the air permeability in l/(m²s) of the textile fabric is 6.76±0.2 (gs)/l.

In another particularly preferred embodiment, the quotient of the weight per unit area in g/m² and the air permeability in l/(m²s) of the textile fabric is 1.63±0.2 (gs)/l.

The textile fabric preferably has a thickness in the range from 0.20 and 5 mm.

When the textile fabric comprises fleece or consists of fleece, the thickness thereof is preferably in the range from 0.20 to 0.8 mm, more preferably 0.25 to 0.39 mm, and most preferably is 0.32 mm.

When the textile fabric comprises felt or consists of felt, the thickness thereof is preferably in the range from 0.20 to 5 mm, more preferably 1.5 to 3.5 mm, and most preferably is 3.2 mm.

In a particularly preferred embodiment, when the textile fabric comprises felt or consists of felt, the thickness thereof is in the range from 2 to 6 mm, more preferably 3 to 5 mm, and most preferably 3.8 to 4.2 mm. According to this embodiment, the textile fabric preferably has a weight per unit area of 1150±10 g/m².

The diameter of the textile fabric can correspond to the internal diameter of the capsule base, but can be larger or smaller.

When the diameter of the textile fabric is larger than the internal diameter of the capsule base, when the single serve capsule is being filled with beverage substance, the textile fabric is pressed onto the bottom region, wherein the projecting rim region is forced to cling to a side wall region of the single serve capsule and protrudes in the direction of the filling side, or is bent in the direction of the filling side. This has the advantage that when a central region of the textile fabric, owing to a mechanical contact with the perforating means penetrating from the outside into the bottom region, is lifted from the bottom, the rim region slides concomitantly in the direction of the capsule base and in the direction of the central region, in such a manner that no beverage substance flows unfiltered past the rim of the textile fabric in the direction of the outlet opening. This permits, in particular, a lifting of the textile fabric from the capsule base, even in the case of a nonelastic textile fabric, without the filter action being impaired. In the case of an elastic textile fabric, the lifting of the central region without impairment of the filter action is at least favored by the concomitantly sliding rim region of the textile fabric, since a combination of extension and concomitantly sliding is also conceivable in the case of perforation of the capsule base.

In a preferred embodiment, the diameter of the textile fabric is 1 to 15% larger than the internal diameter of the capsule base.

The textile fabric can be fastened on the capsule base, or merely lie on the capsule base.

In a preferred embodiment, the textile fabric is simply placed into the capsule base body and is thus arranged on the base of the single serve capsule in such a manner that as large an area as possible is adjacent. Then, the beverage substance can be charged into the capsule base body. Preferably, in this case, the textile fabric is fixed to the capsule base by the overlying beverage substance.

In another preferred embodiment, the textile fabric is connected to the capsule base, for example by gluing or sealing. Sealing is preferably performed by means of ultrasound.

Particularly preferably, the textile fabric having a felt structure is sealed to the capsule base, in particular by ultrasound.

If the textile fabric has one or more felt structures and a supporting structure, the structures are arranged one above the other in the single serve capsule and optionally connected to one another.

If the textile fabric comprises fleece or consists of fleece, the fleece is particularly preferably sealed to the capsule base, in particular by ultrasound.

Additionally preferably, the fleece, before the fixing thereof to the capsule, in particular the capsule base, is tensioned, in order to improve the arrangement onto the base.

The weight of the empty capsule base body including the textile fabric is 1.00 to 2.50 g.

Preferably, the weight of the empty capsule base body including the textile fabric is in the range from 1.00 to 1.80 g, more preferably 1.10 to 1.70 g, still more preferably 1.20 to 1.60 g, most preferably 1.30 to 1.50, and in particular 1.35 to 1.41 g.

In another, particularly preferred embodiment, the weight of the empty capsule base body including the textile fabric is in the range from 1.70 to 2.50 g, more preferably 1.80 to 2.40 g, still more preferably 1.90 to 2.30 g, most preferably 2.00 to 2.20, and in particular 2.08 to 2.14 g.

To protect the beverage substance from moisture and oxygen and to increase the storage stability of the single serve capsules, the single serve capsules are preferably charged with inert gas, in such a manner that a slight overpressure is formed in the interior of the capsules.

The inert gas is preferably nitrogen.

The single serve capsule can be provided with an identifier. Thus, for example, a mechanical identifier or a mechanical matching of the single serve capsule with a matching element of the device for producing the coffee beverage can be achieved via the above-described grooves in the wall region of the capsule base body. Furthermore, identifiers based on electrical conductivity or magnetism can also be used.

The brewing pressure is affected under standardized conditions by the D[4,3] value of the ground coffee, and also by the amount of beverage substance present in the single serve capsule.

The brewing pressure is preferably in the range from 1 to 18 bar.

The brewing pressure preferably designates the measured pressure which the pump must apply in order to pump water in and through the single serve capsule which is situated in the brewing chamber.

Preferred embodiments F¹ to F¹⁰ are summarized in the table hereinafter:

| | F¹ | F² | F³ | F⁴ | F⁵ | F⁶ | F⁷ | F⁸ | F⁹ | F¹⁰ |
|---|---|---|---|---|---|---|---|---|---|---|
| Brewing | 2-5 | 3-6 | 4-6 | 4-8 | 6-8 | 6.5-10 | 8-10 | 9-12 | 11-13 | 13-15 |
| pressure | | | | | | | | | | |
| [bar] | | | | | | | | | | |

Particular preference is given to embodiments F² to F⁹.

Using the single serve capsule according to the invention, various coffee beverages can be produced.

Preferred coffee beverages are espresso and filter coffee, more preferably filter coffee.

Preferably, the expression “filter coffee” designates a coffee beverage having a volume of greater than 80 ml which does not have a crema and corresponds to a coffee beverage which can be prepared using unpressurized filtration apparatuses.

The achievable beverage volume can be in the range from 20 to 400 ml.

If the coffee beverage is espresso, the achievable beverage volume is preferably between 30 and 50 ml.

The achievable beverage volume is preferably in the range from 80 to 350 ml.

If the coffee beverage is filter coffee, the achievable beverage volume is preferably between 80 and 180 ml, or 150 and 330 ml.

In a particularly preferred embodiment, the achievable beverage volume is between 80 and 180 ml, and in particular between 100 and 150 ml.

In a further particularly preferred embodiment, the achievable beverage volume is between 150 and 330 ml, and in particular between 180 and 300 ml.

The coffee beverage that is to be produced can have a crema.

In a preferred embodiment, the coffee beverage has a crema. According to this embodiment, the achievable beverage volume is preferably between 30 and 50 ml.

In a particularly preferred embodiment, the coffee beverage does not have a crema. According to this embodiment, the achievable beverage volume is preferably between 80 and 350 ml, more preferably between 80 and 180 ml, or between 150 and 330 ml, most preferably between 100 and 150 ml, or between 180 and 300 ml.

Preferred combinations of particularly preferred embodiments are summarized in the following table:

| | | Textile fabric | | | |
|---|---|---|---|---|---|
| D [4, 3] | Amount of | Weight per | Air | Brewing | Achievable |
| value | coffee [g] | unit area | permeability | pressure | volume [ml] |
| 200-650 μm | 7-10 | >500 g/m² | >100 1 (m²s) | F⁴ | 80-350 |
| 300-400 μm | 8 ± 0.5 | E¹⁰ | D¹¹ | F³ | 80-180 |
| B⁴ | 8 ± 0.5 | E¹⁹ | D³⁵ | F³ | 100-150 |
| 350-600 μm | 9 ± 0.5 | E¹⁴ | D² | F⁴ | 150-330 |
| B⁵_B⁷ | 9 ± 0.5 | E²³ | D³² | F⁵ | 180-300 |
| B⁸ | 9 ± 0.5 | E²³ | D³² | F³ | 180-300 |

### EXEMPLARY EMBODIMENTS

The degree of roasting was determined using the color measuring instrument Colorette 3b from Probat; constructed 2011. The principle of measurement is based on reflection measurement. In this case the coffee sample that is to be measured is illuminated with light of two wavelengths (red light and infrared). The sum of the reflected light is evaluated electronically and displayed as a color value. Very dark roasted raw coffee gives measured values between 50 and 70. Coffee beans roasted in a medium-strength to light manner have values above 70.

The particle size distribution and D[4,3] value were determined in a dry measurement using the Malvern Mastersizer 3000 measuring instrument and the Malvern AeroS dispersion unit. For this purpose, approximately 7 g of ground roast coffee were transferred into the measuring cell at a dispersion pressure of 4 bar. The particle size distribution may be determined using laser diffraction and the D[4,3] value may be determined by detecting the scattered light and the diffraction angle resulting therefrom in accordance with the Fraunhofer theory.

The air permeability of the textile fabric was determined as specified in DIN ISO 9237. For this purpose, a defined area of the sample material was tensioned. Air flowed through the sample perpendicularly to the surface. The measurement can proceed as vacuum or differential pressure determination. The air permeability was determined at a pressure of 100 pascals.

The weight per unit area of the textile fabric was determined as specified in DIN EN 12127.

The brewing pressure designates the measured pressure which the pump must apply to pump water in and through the single serve capsule which is situated in the brewing chamber.

As evaluation criterion, the sensory evaluation of the beverage was used, both with respect to visual properties, based on the freedom from crema, and also with respect to taste properties. With an open capsule base, little or even no crema is formed. Samples were designated crema-free when the small amount of foam or bubbles had disappeared within 10 seconds. In the taste testing, on a point scale from 0 to 6, a value between 5.0 and 6.0 had to be achieved (0=displeasing, 3=neither pleasing nor displeasing, 6=extremely pleasing).

Substantially the criteria roastiness, bitterness, acidity, sweetness and possibly body were substantially used. The testing was performed by trained sensory testers.

### Exemplary Embodiment 1

Various coffee beverages were produced using flat-permeable and porous-cascade-like textile fabrics with a D[4,3] value of the coffee of 350 μm (table 1).

The test series 1 and 2 of table 1 verify that it is possible, with color values between 70 and 120, and a fine degree of grinding (expressed via the D[4,3] value) in combination with the respective textile fabric to be able to achieve beverages that are faultless in sensory properties with beverage volumes of 30 ml to 150 ml; this is also possible with crema (test series 1) (comparative example)) and also crema-free (test series 2). In contrast, with lower color values, good sensory properties were not achievable (test series 3).

### Exemplary Embodiment 2

Various coffee beverages were produced using differing porous-cascade-like textile fabrics (table 2).

In test series 4 to 9, comparative investigations are shown in order to achieve crema-free beverages having a high beverage volume. In this case, porous-cascade-like textile fabrics with changing weights per unit area and differing air permeabilities are used. Interestingly, although high weights per unit area result in absolute cream freedom, although the brewing pressure increases—test series 8—not until after the change in air permeability of the textile fabric—test series 9—, is a beverage with outstanding sensory properties formed. Changes in the degree of roasting (color values 90 to 120) do not produce good beverages.

### Exemplary Embodiment 3

Various coffee beverages were produced using a porous-cascade-like textile fabric, with differing D[4,3] values of the coffee (table 3).

From test series 10 to 12 and 9 (Table 2), it can be seen that using these textile fabrics (weight per unit area 1150 g/m², air permeability 170 l/(m²s)), a broad range of degrees of grinding (expressed via the D[4,3] value) can be used despite increasing brewing pressures. In contrast, with color values between 70 and 120, it is not possible to achieve beverages with satisfactory sensory qualities.

TABLE 1
Use of flat-permeable and porous-cascade-type textile fabrics with a D[4,3] value of the
coffee of 350 mm.

| | | | | | | Properties of the textile fabric at | | | |
|---|---|---|---|---|---|---|---|---|---|
| | | | | | | the base of the capsule | | | |
| | Properties of the coffee powder | | | | | | a) | | |
| | Degree | | | | | | weight | | |
| | of | | | | | | per | | |
| | grinding | | | | Weighed | | unit | b) air | |
| Test | D4,3 | | | Color | portion | Textile | area | permeability | Capsule |
| series | [μm] | from-to | preferably | Colorette | [g] | fabric | [g/m²] | [l/m²s] | base |
| 1 | 350 | 300-400 | 325-375 | 70-120 | 7.5-8.5 | flat- | 70 | 2000 | closed |
| (comp.) | | | | | | permeable | | | |
| 2 | 350 | 300-400 | 325-375 | 70-120 | 7.5-8.5 | porous- | 650 | 400 | open |
| | | | | | | cascade- | | | |
| | | | | | | type | | | |
| 3 | 350 | 300-400 | 325-375 | 50-70 | 7.5-8.5 | porous- | 650 | 400 | open |
| | | | | | | cascade- | | | |
| | | | | | | type | | | |

| | Properties of the hot drink obtained | | | | |
|---|---|---|---|---|---|
| | | Achievable | | | |
| | Brewing | beverage | | | |
| Test | pressure | volume | | | |
| series | [bar] | [ml] | Crema | Taste | Ranking |
| 1 | 6.5-10.0 | 30-120 | yes | fruity- | 5.0-6.0 |
| (comp.) | | | | acidic, | |
| | | | | aromatic | |
| | | | | roast | |
| | | | | note, | |
| | | | | harmonic | |
| | | | | sweetness | |
| 2 | 4.0-6.0 | 100-150 | none | strong, | 5.5-6.0 |
| | | | | full body | |
| | | | | with | |
| | | | | fruity | |
| | | | | acidity, | |
| | | | | slight | |
| | | | | sweetness | |
| 3 | 4.0-6.0 | 100-150 | none | acid, | 3.0-4.0 |
| | | | | bitter, | |
| | | | | very | |
| | | | | powerful, | |
| | | | | astringent | |

TABLE 2
Use of various porous-cascade-type textile fabrics.

| | | | | | | Properties of the textile fabric | | | |
|---|---|---|---|---|---|---|---|---|---|
| | | | | | | at the base of the capsule | | | |
| | Properties of the coffee powder | | | | | | a) | | |
| | Degree | | | | | | weight | | |
| | of | | | | | | per | | |
| | grinding | | | | Weighed | | unit | b) air | |
| Test | D4,3 | | | Color | portion | Textile | area | permeability | Capsule |
| series | [μm] | from-to | preferably | Colorette | [g] | fabric | [g/m²] | [l/m²s] | base |
| 4 | 550 | 500-600 | 525-575 | 50-90 | 8.5-9.4 | porous- | 650 | 400 | open |
| | | | | | | cascade- | | | |
| | | | | | | like | | | |
| 5 | 550 | 500-600 | 525-575 | 50-90 | 8.5-9.4 | porous- | 760 | 281 | open |
| | | | | | | cascade- | | | |
| | | | | | | like | | | |
| 6 | 550 | 500-600 | 525-575 | 50-90 | 8.5-9.4 | porous- | 900 | 193 | open |
| | | | | | | cascade- | | | |
| | | | | | | like | | | |
| 7 | 550 | 500-600 | 525-575 | 50-90 | 8.5-9.4 | porous- | 1000 | 160 | open |
| | | | | | | cascade- | | | |
| | | | | | | like | | | |
| 8 | 550 | 500-600 | 525-575 | 50-90 | 8.5-9.4 | porous- | 2 × 650 | 400 | open |
| | | | | | | cascade- | | | |
| | | | | | | like | | | |
| 9 | 550 | 500-600 | 525-575 | 50-90 | 8.5-9.4 | porous- | 1150 | 170 | open |
| | | | | | | cascade- | | | |
| | | | | | | like | | | |

| | Properties of the hot drink obtained | | | | |
|---|---|---|---|---|---|
| | | Achievable | | | |
| | Brewing | beverage | | | |
| Test | pressure | volume | | | |
| series | [bar] | [ml] | Crema | Taste | Ranking |
| 4 | 4.0-6.0 | 180-300 | full- | aromatic, | 4.0-5.0 |
| | | | surface | full | |
| | | | | bodied, | |
| | | | | pleasant | |
| | | | | acid, | |
| | | | | slightly | |
| | | | | sweet | |
| 5 | 4.0-6.0 | 180-300 | little, | aromatic, | 4.0-5.0 |
| | | | but | full | |
| | | | full- | bodied, | |
| | | | surface | pleasant | |
| | | | | acid, | |
| | | | | slightly | |
| | | | | sweet | |
| 6 | 4.0-6.0. | 180-300 | somewhat | sour, | 2.5-3.05 |
| | | | | roasty, | |
| | | | | lack of | |
| | | | | sweetness, | |
| | | | | bitter | |
| 7 | 4.0-6.0 | 180-300 | very | sour, | 2.5-3.05 |
| | | | little | roasty, | |
| | | | | lack of | |
| | | | | sweetness, | |
| | | | | bitter | |
| 8 | 4.0-8.0 | 180-300 | none | roasty- | 2.0-3.0 |
| | | | | acidic, | |
| | | | | flat body, | |
| | | | | bitter | |
| 9 | 4.0-6.0 | 180-300 | none | full, | 6.0 |
| | | | | harmonic | |
| | | | | body, | |
| | | | | slightly | |
| | | | | sweet | |

TABLE 3
Use of a porous-cascade-type textile fabric with differing D[4,3] values.

| | | | | | | Properties of the textile fabric | | | |
|---|---|---|---|---|---|---|---|---|---|
| | | | | | | at the base of the capsule | | | |
| | Properties of the coffee powder | | | | | | a) | | |
| | Degree | | | | | | weight | | |
| | of | | | | | | per | | |
| | grinding | | | | Weighed | | unit | b) air | |
| Test | D4,3 | | | Color | portion | Textile | area | permeability | Capsule |
| series | [μm] | from-to | preferably | Colorette | [g] | fabric | [g/m²] | [l/m²s] | base |
| 10 | 400 | 350-450 | 375-425 | 50-70 | 8.5-9.4 | porous- | 1150 | 170 | open |
| | | | | | | cascade- | | | |
| | | | | | | like | | | |
| 11 | 450 | 400-500 | 425-475 | 50-70 | 8.5-9.4 | porous- | 1150 | 170 | open |
| | | | | | | cascade- | | | |
| | | | | | | like | | | |
| 12 | 500 | 450-550 | 475-525 | 50-70 | 8.5-9.4 | porous- | 1150 | 170 | open |
| | | | | | | cascade- | | | |
| | | | | | | like | | | |

| | Properties of the hot drink obtained | | | | |
|---|---|---|---|---|---|
| | | Achievable | | | |
| | Brewing | beverage | | | |
| Test | pressure | volume | | | |
| series | [bar] | [ml] | Crema | Taste | Ranking |
| 10 | 6.0-8.0 | 180-300 | none | aromatic | 6.0 |
| | | | | acid and | |
| | | | | roasting | |
| | | | | note, full | |
| | | | | bodied | |
| 11 | 6.0-8.0 | 180-300 | none | fruity- | 6.0 |
| | | | | aromatic, | |
| | | | | harmonic | |
| | | | | body, | |
| | | | | slightly | |
| | | | | acidic- | |
| | | | | floral | |
| 12 | 6.0-8.0 | 180-300 | none | fruity- | 6.0 |
| | | | | aromatic, | |
| | | | | harmonic | |
| | | | | body, | |
| | | | | slightly | |
| | | | | acidic- | |
| | | | | floral | |

1. A single serve capsule for producing a coffee beverage,
wherein the single serve capsule has a capsule base body in which a textile fabric and a beverage substance are arranged,
wherein the beverage substance is provided for storage in the single serve capsule and for extraction in the single serve capsule through the textile fabric by means of pressurized hot water,
wherein the beverage substance is present in the single serve capsule in an amount in the range from 1 to 20 g;
wherein the beverage substance is substantially pulverulent, comprises roasted, ground coffee which in the dry state has a D[4,3] value in the range from 100 to 800 μm;
wherein the textile fabric has a weight per unit area of at least 100 g/m²; and
wherein the textile fabric has an air permeability of at least 50 l/(m²s).

2. The single serve capsule as claimed in claim 1, wherein the textile fabric has an air permeability of at least 100 l/(m²s).

3. The single serve capsule as claimed in claim 1, wherein the textile fabric has an air permeability in the range from 160 to 500 l/(m²s).

4. The single serve capsule as claimed in claim 1, wherein the textile fabric has a weight per unit area of at least 500 g/m².

5. The single serve capsule as claimed in claim 1, wherein the textile fabric has a weight per unit area of more than 900 g/m².

6. The single serve capsule as claimed in claim 1, wherein the textile fabric has an air permeability of more than 160 l/(m²s) and a weight per unit area of more than 900 g/m².

7. The single serve capsule as claimed in claim 1, wherein the beverage substance is present in the single serve capsule in an amount in the range from 4 to 11 g.

8. The single serve capsule as claimed in claim 1, wherein the beverage substance is substantially pulverulent, comprises roasted, ground coffee which in the dry state has a D[4,3] value in the range from 200 to 650 μm.

9. The single serve capsule as claimed in claim 1, wherein the capsule base body is partially open.

10. The single serve capsule as claimed in claim 1, wherein the capsule base body is partially open.

11. The single serve capsule as claimed in claim 1, wherein the coffee beverage does not have a crema.

12. The single serve capsule as claimed in claim 1, wherein the achievable beverage volume is in the range from 80 to 350 ml.

13. The single serve capsule as claimed in claim 1, wherein the quotient of the weight per unit area in g/m2 and the air permeability in l/(m2s) of the textile fabric is at least 1 (gs)/l.

14. The single serve capsule as claimed in claim 1, wherein the brewing pressure is in the range from 1 to 18 bar.

15. (canceled)
